(19) United States
(12) Patent Application Publication
(10) Pub. No.: US 2020/0005643 A1
(43) Pub. Date: Jan. 2, 2020

(54) METHOD AND APPARATUS FOR PROVIDING INFORMATION ON VEHICLE DRIVING

(71) Applicant: LG ELECTRONICS INC., Seoul (KR)

(72) Inventors: Minkyu PARK, Seoul (KR); Ahyoung SHIN, Seoul (KR)

(73) Assignee: LG ELECTRONICS INC., Seoul (KR)

(21) Appl. No.: 16/557,855

(22) Filed: Aug. 30, 2019

(30) Foreign Application Priority Data
Aug. 19, 2019 (KR) 10-2019-0100947

(51) Int. Cl. G08G 1/16; B60W 40/09

(52) U.S. Cl. CPC G08G 1/161; B60W 40/09; B60W 2750/40; B60W 2540/30; B60W 2550/402

(57) ABSTRACT

One or more of an autonomous vehicle, a user terminal, and a server of the present disclosure is connectable to or combinable with, for example, an artificial intelligence module, an unmanned aerial vehicle (UAV), a robot, an augmented reality (AR) device, a virtual reality (VR) device, or a 5G service device. A method of providing driving information of a vehicle from an operating apparatus according to one embodiment of the present disclosure includes acquiring vehicle driving history information of a driver, estimating driving information of a vehicle based on the acquired history information, and transmitting the vehicle driving information, estimated based on the identified information, to a target vehicle when the estimated information satisfies a specific condition.

### CROSS-REFERENCE TO RELATED APPLICATION

Pursuant to 35 U.S.C. § 119(a), this application claims the benefit of earlier filing date and right of priority to Korean Patent Application No. 10-2019-0100947, filed on Aug. 19, 2019, the contents of which are hereby incorporated by reference herein in its entirety.

### BACKGROUND

### 1. Field

Embodiments of the present disclosure relate to a method of providing, by an operating apparatus associated with a vehicle, information on the driving of the vehicle to another subject and an apparatus for the same. More specifically, embodiments of the present disclosure relate to a method of providing, by an operating apparatus associated with a vehicle, information on the driving of the vehicle to another subject based on at least one of driver information and navigation information and an apparatus for the same.

### 2. Description of the Related Art

In relation to the driving of a vehicle, devices, such as a navigation device, have been provided, in which an operating apparatus associated with a vehicle provides a driver with a driving route and additional related information based on information input by the driver and information received from an external source. In addition, recently, information on a vehicle may be provided to another vehicle or another subject via vehicle-to-vehicle (V2V) communication or vehicle-to-everything (V2X) communication.

As such, information may be provided to a driver for driving convenience, and such information may include information collected by sensors of a vehicle. A vehicle may utilize information provided thereto for driving, and an external device such as a server may store and process information received from the vehicle to derive and use statistical feature information on vehicle driving. Through the provision of additional information to a vehicle through a system, vehicle accidents may be prevented and driver usability may be improved under the assistance of information. However, there is a need to provide more specific information since only information collected by sensors or information derived using only collected statistical information have been provided.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Embodiments of the present disclosure are proposed to address the above description, and provide a method and apparatus of estimating information on future vehicle driving using vehicle driver information and transmitting the estimated information to another user or server. In addition, embodiments of the present disclosure provide a method and apparatus of estimating future vehicle driving based on vehicle route guidance information and the current state of a vehicle and transmitting the estimated information to another vehicle or server. In addition, embodiments of the present disclosure provide a method and apparatus of estimating future vehicle driving based on driver's driving history and transmitting the estimated information to another vehicle or server.

A method of providing driving information of a vehicle from an operating apparatus according to one embodiment of the present disclosure includes acquiring vehicle driving history information corresponding to a driver, estimating driving information of a vehicle based on the acquired history information, and transmitting, to a target vehicle, information on driving of the vehicle identified based on the estimated driving information, when the estimated information corresponds to a specific condition.

An operating apparatus of providing driving information according to another embodiment of the present disclosure includes a transceiver configure to communicate with another vehicle, and a controller configured to: control the transceiver, estimate driving information of a vehicle based on the acquired history information, and transmit, to a target vehicle, information on driving of the vehicle identified based on the estimated driving information, when the estimated information corresponds to a specific condition.

An operating apparatus of displaying driving information according to a further embodiment of the present disclosure includes a display, a transceiver, and a controller configured to: receive driving information including information on driving of another vehicle through transceiver, and control the display to display the received driving information of the other vehicle, wherein the driving information includes information on the driving of the other vehicle estimated based on driving history information of a driver of the other vehicle.

According to the embodiments of the present disclosure, by estimating information on future driving of a vehicle using, for example, vehicle route guidance information, the current state of the vehicle, and driver's driving history, and providing the estimated information to another vehicle or server, it is possible to reduce the probability of accidents related to the vehicle. In addition, by collecting response results of other vehicles to the aforementioned information, it is possible to ensure more efficient information exchange between vehicles.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device according to an embodiment of the present disclosure.

FIG. 2 illustrates an AI server according to an embodiment of the present disclosure.

FIG. 3 illustrates an AI system according to an embodiment of the present disclosure.

FIG. 4 is a flowchart illustrating a method of identifying driving information, estimating a driver's unexpected behavior, and providing such information to another vehicle by an operating apparatus according to an embodiment of the present disclosure.

FIG. 5 is a flowchart for explaining an operation to be performed by an operating apparatus when receiving driving information from another vehicle according to an embodiment of the present disclosure.

FIG. 6 is a view for explaining an unexpected situation according to one embodiment of the present disclosure.

FIG. 7 is a view for explaining an unexpected situation according to another embodiment of the present disclosure.

FIG. 8 is a view for explaining an unexpected situation based on navigation information according to an embodiment of the present disclosure.

FIG. 9 is a flowchart illustrating a method of providing information to another vehicle based on information on the driving history of a driver according to still another embodiment of the present disclosure.

FIG. 10 is a flowchart illustrating a method of providing information to another vehicle based on information on the driving pattern of a driver according to yet another embodiment of the present disclosure.

FIG. 11 is a view for explaining the operating apparatus according to the embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

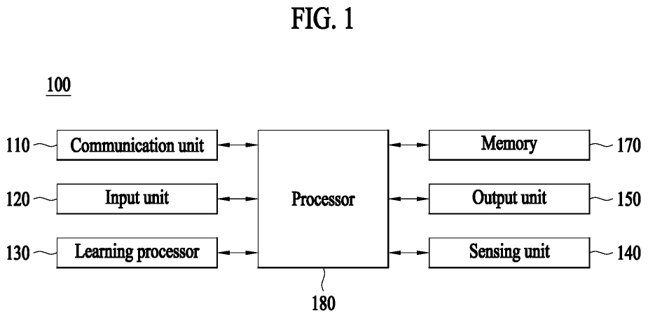

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices. Meanwhile, an element referred to as a communication unit 110 throughout the specification may be a transceiver capable of transmitting and receiving a signal.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

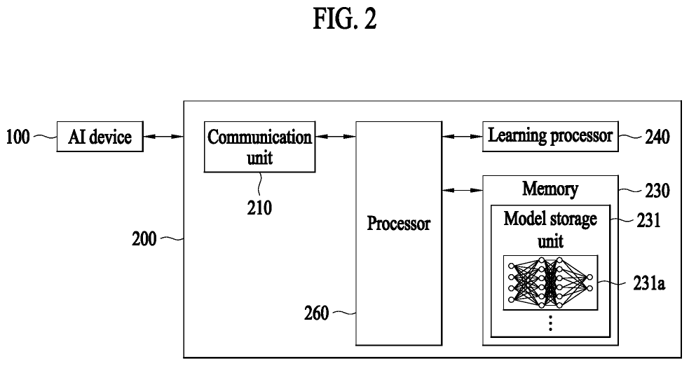

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

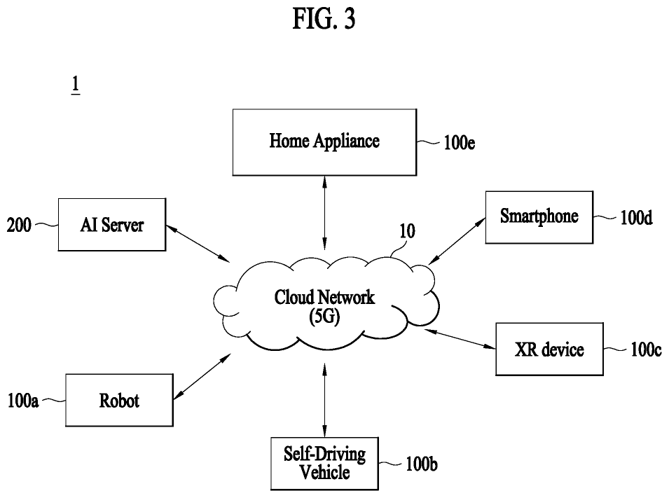

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a specific distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

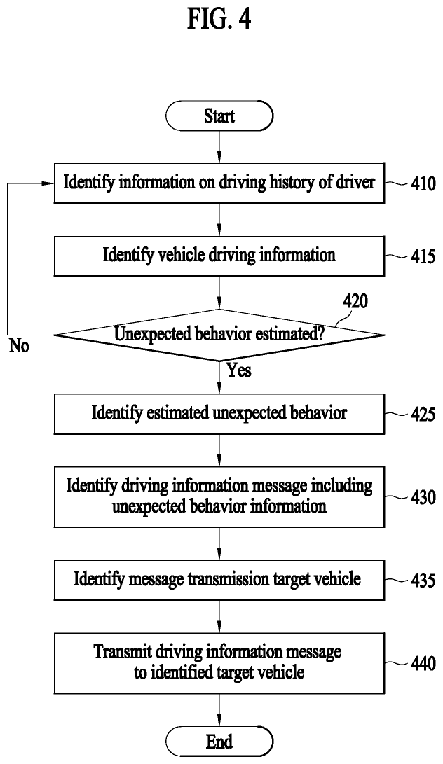

FIG. 4 is a flowchart illustrating a method of identifying driving information, estimating a driver's unexpected behavior, and providing such information to another vehicle by an operating apparatus according to an embodiment of the present disclosure.

Referring to FIG. 4, there is illustrated a method of identifying vehicle driving information and transmitting the information to another vehicle by an operating apparatus.

In step 410, the operating apparatus may identify history information of a driver. In an embodiment, the history information may include information on the driving experience of the driver in the area in which a vehicle is currently located. In addition, the history information may include information about how the driver of the vehicle drove in an area similar to the area in which the vehicle is currently located. The operating apparatus may estimate a driver's behavior in an environment in which the vehicle is currently located based on the history information described above.

In step 415, the operating apparatus may identify vehicle driving information. In an embodiment, the driving information may include route guidance information that is currently provided in relation to the vehicle. For example, the route guidance information may include information provided by a navigation system to guide a route to a destination.

In addition, in an embodiment, the vehicle driving information may include the current location and speed of the vehicle. In an embodiment, the vehicle driving information may include at least one of information on the location of the vehicle on a three-dimensional coordinate system, information on the lane of the road in which the vehicle is located, information on the speed of the vehicle, and information on the heading direction of the vehicle. In addition, the vehicle driving information may include information on the current state of the vehicle.

In operation 420, the operating apparatus may determine whether an unexpected behavior is estimated based on at least one of the identified information. In an embodiment, the unexpected behavior may include a situation in which a sudden change may occur in the current driving state of the vehicle due to driver's manipulation. For example, the unexpected behavior may include a sudden lane change, a sudden speed change, and unevenness of the heading direction. In addition, in an embodiment, the unexpected behavior may include driver's manipulation that may have an influence on the driving of a peripheral vehicle.

In an embodiment, the operating apparatus may determine, based on at least one of driver's driving history information and vehicle driving information, whether the unexpected behavior is estimated.

In an embodiment, the operating apparatus may identify the probability of the unexpected behavior based on at least some of the information identified in the previous steps. In an embodiment, the operating apparatus may determine that the unexpected behavior occurs when the probability of the unexpected behavior falls within a specific range. For example, the operating apparatus may determine that the unexpected behavior occurs when the probability of the unexpected behavior is 50% or more, but such a specific value may be changed according to applications.

In step 425, the operating apparatus may check information on the estimated unexpected behavior. In an embodiment, the unexpected behavior information may include at least one of a change in the speed of the vehicle and a change in the heading direction of the vehicle, which are caused by the unexpected behavior. In addition, in an embodiment, the unexpected behavior information may include information on the probability of the unexpected behavior.

In step 430, the operating apparatus may check a driving information message based on the identified unexpected behavior information. In an embodiment, the operating apparatus may generate a driving information message including at least one of information on a change in the speed of the vehicle and a change in the heading direction of the vehicle, which are caused by the unexpected behavior, and information on the probability of the unexpected behavior. In an embodiment, the driving information message may include at least one of information on the current location of the vehicle, information on the current driving of the vehicle, and information on the unexpected behavior that may occur in the vehicle.

For example, in an embodiment, the driving information message may include information on the direction in which the vehicle may move and the speed of the vehicle. In an embodiment, the driving information message may include at least one of information on the current location of the vehicle, information on the current speed of the vehicle, information on the movement of the vehicle depending on the unexpected behavior, and information on the speed of the vehicle depending on the unexpected behavior.

In step 435, the operating apparatus may identify a target vehicle to which the driving information message is to be transmitted. For example, the operating apparatus may broadcast the driving information message around the vehicle, instead of identifying a separate target vehicle.

In an embodiment, the transmission target vehicle may include a vehicle which may be affected by the unexpected behavior of the vehicle associated with the operating apparatus. In this case, the operating apparatus may determine the transmission target vehicle based on the unexpected behavior information and information on a peripheral vehicle. In an embodiment, the peripheral vehicle information may include at least one of information on the location of the peripheral vehicle, information on the speed of the peripheral vehicle, and information about whether the peripheral vehicle is performing autonomous driving. For example, when there is the probability that the vehicle changes the lane due to the unexpected behavior, the operating apparatus may identify, as the transmission target vehicle, a peripheral vehicle within a specific range among peripheral vehicles which are driving in the lane to which the vehicle is to move. In addition, in an embodiment, the operating apparatus may identify, as a message transmission target, a server which may communicate with the vehicle.

In addition, in an embodiment, the target vehicle may be determined based on information received through the server. At this time, the server may determine the target vehicle, to which the message is to be transmitted, based on a road situation and may provide information on the target vehicle to the vehicle.

In step 440, the operating apparatus may transmit the driving information message to the identified target vehicle. In an embodiment, the operating apparatus may transmit the driving information message to the target vehicle multiple times, and the transmission target vehicle may include a vehicle from which a response message to the transmitted message has been transmitted to the operating apparatus.

In an embodiment, the operating apparatus may correspond to a vehicle, and for example, may take the form of a system on chip (SoC) mounted in the vehicle. The operating apparatus described above may identify additional information based on information collected by sensors of the vehicle, and may control the operation of the vehicle or may communicate with another node based on the identified information. In an embodiment, another vehicle may be a vehicle including an operating apparatus, and a transmission target is not limited to a vehicle. In an embodiment, the operating apparatus may transmit a message to a specific server as a transmission target.

Meanwhile, in an embodiment, the operating apparatus of a vehicle may transmit information on an expected driving route of the vehicle to another vehicle. For example, the operating apparatus may transmit, to the other vehicle, a driving information message including at least one of expected driving route information of the vehicle, heading direction information of the vehicle, driving lane information of the vehicle, speed information of the vehicle, and driving history information of the driver. In an embodiment, the other vehicle may acquire the vehicle heading direction information, the vehicle speed information, and the vehicle driving lane information by identifying the vehicle using an image sensor provided therein. The other vehicle may determine, based on the information acquired by the sensor thereof and the driving information message, that the vehicle which has transmitted the driving information message has the probability of the unexpected behavior. For example, when the other vehicle which has received the driving information message determines, based on the driving information message, that the vehicle which has transmitted the driving information message has a high probability of making a sudden lane change to move along a driving route, the other vehicle which has received the driving information message may sense related information and may provide the information to a driver of the other vehicle or may transmit the information to at least one of the vehicle and the server. In this way, since the driving information message is transmitted to the other vehicle or the server and the driving information message includes information that assists the other vehicle in determining whether the vehicle associated with the operating apparatus has the probability of the unexpected behavior, the other vehicle may determine whether the vehicle has the probability of the unexpected behavior. Moreover, by providing such information on the probability of the unexpected behavior to at least one of the driver of the other vehicle, the vehicle associated with the operating apparatus, and the server, improved usability may be obtained. In addition, in an embodiment, the operating apparatus of the vehicle may generate a driving information message, may determine whether the driver actually made the unexpected behavior related to information included in the driving information message, and may determine whether the vehicle has the probability of the unexpected behavior.

In addition, in an embodiment, the operating apparatus may perform learning based on existing driver's driving data which is acquired by an AI module based on driving history information, and may determine whether the driver makes an unexpected behavior in a specific situation. In this way, information included in the driving information message may be derived by the AI module in consideration of a current situation based on the driving history information.

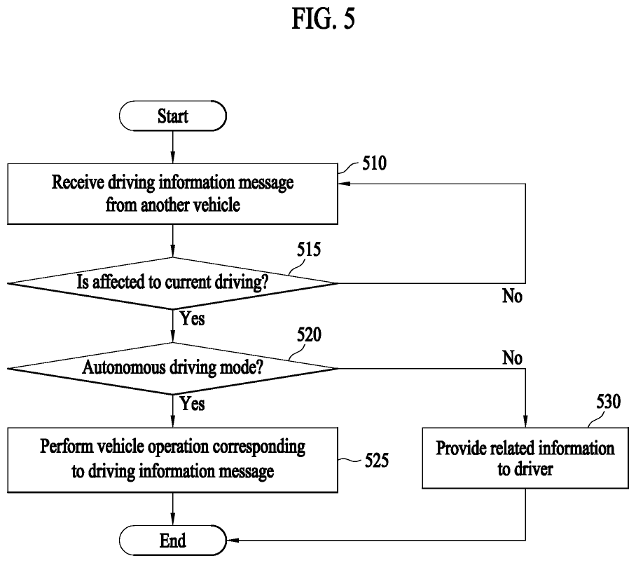

FIG. 5 is a flowchart for explaining an operation to be performed by an operating apparatus when receiving driving information from another vehicle according to an embodiment of the present disclosure.

Referring to FIG. 5, there is illustrated a method of controlling a vehicle, by the operating apparatus of the vehicle, based on a driving information message received from another vehicle.

In step 510, the operating apparatus may receive a driving information message from another vehicle. In an embodiment, the driving information message may include information on the driving of the other vehicle. For example, the driving information may include current driving information of the other vehicle and information on a change in at least one of the speed and the direction of the other vehicle.

For example, the driving information message may include at least one of the probability of an unexpected behavior of the other vehicle and information on an estimated driving direction and speed of the other vehicle due to the unexpected behavior, and the driving direction and speed information may include vector information related to the direction and speed which change based on the current location and speed of the other vehicle.

In step 515, based on the received information, the operating apparatus may identify whether the driving information of the other vehicle has an influence on the driving of a vehicle associated with the operating apparatus. For example, the operating apparatus may determine, based on information included in the driving information message, that the driving information has an influence on the current driving of the vehicle when the location to which the other vehicle may move and the current location of the vehicle associated with the operating apparatus correspond to each other. In another example, when the vehicle is in a manual driving mode and the other vehicle enters the driver's field of vision, the operating apparatus may determine that the current driving of the vehicle is affected.

In step 520, the operating apparatus may identify whether the vehicle associated with the operating apparatus is in an autonomous driving mode.

When the autonomous driving mode is identified, in step 525, the operating apparatus may operate the vehicle associated with the operating apparatus based on the driving information message. Then, the operating apparatus may provide related information to an occupant. In an embodiment, an operation of providing information to an occupant may be selectively performed.

When the manual driving mode is identified, in step 530, the operating apparatus may provide the driver with information on the other vehicle based on the driving information message. For example, the operating apparatus may display information on the direction to which the other vehicle may move and the speed of the other vehicle based on the driving information message. For example, the operating apparatus may display an image of the other vehicle on an expected movement route of the other vehicle through augmented reality.

In an embodiment, the driving information message from the other vehicle may be directly received from the other vehicle, and at this time, a network may relay the transmission of the message. In another embodiment, the driving information message may be received from a separate server. The separate server may generate a driving information message based on information on the driving of the other vehicle.

In addition, in an embodiment, the operating apparatus of the vehicle may receive the driving information message from the other vehicle, and may determine, based on the message, whether the other vehicle has the probability of the unexpected behavior. For example, the driving information message may include information on the movement route of the other vehicle and information on the driving history of the other vehicle, and the vehicle which has received the message may determine the probability of the unexpected behavior of the other vehicle based on the driving information message. Then, based on the determined result, the operating apparatus may perform at least one of an operation of providing related information to the driver of the vehicle and an operation of transmitting related information to the other vehicle or the server.

In addition, in an embodiment, the operating apparatus of the vehicle may receive the driving information message, and may detect whether the other vehicle which has transmitted the driving information message actually made the unexpected behavior. For example, the vehicle which has received the driving information message may identify, using sensors thereof, whether the other vehicle which has transmitted the driving information message made the unexpected behavior. The operating apparatus of the vehicle which has received the driving information message may transmit feedback information based on the identified result to an operating apparatus of the other vehicle which has transmitted the driving information message. In addition, the feedback information may be transmitted to a separate server. The driver's driving history information may be updated based on the feedback information, and whether the unexpected behavior occurs in the future may be determined based on the updated history information.

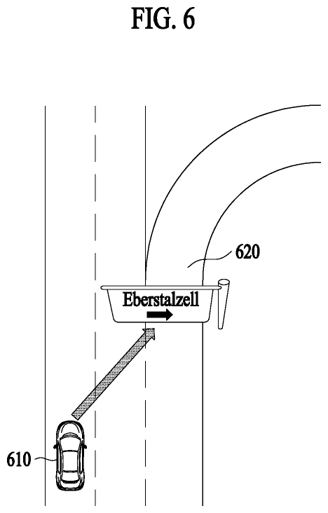

FIG. 6 is a view for explaining an unexpected situation according to one embodiment of the present disclosure.

Referring to FIG. 6, there is illustrated an environment in which a sudden lane change may occur near the route along which a driving vehicle is guided.

The embodiment describes the case in which a vehicle 610 is traveling in the first lane and the route guided by a navigation system of the vehicle is directed to an exit 620 of the road. Vehicle 610 may make a rapid lane change from the first lane toward exit 620 in order to move along the guided route.

At this time, an operating apparatus associated with vehicle 610 may estimate a future movement direction of vehicle 610 based on the current location of the vehicle, guided route information, the current speed of the vehicle, and driving history information of the vehicle. At this time, the vehicle is expected to reduce the speed and rapidly change lanes to enter exit 620, and the operating apparatus may generate a driving information message including related information and transmit the message to another node.

In addition, in an embodiment, the operating apparatus may estimate the probability of a rapid lane change based on the current location of the vehicle, guided route information, the current speed of the vehicle, and driving history information of vehicle 610. In an embodiment, whether or not to transmit a driving information message to another node may be determined based on the probability of the rapid lane change. In addition, in an embodiment, the driving information message may include probability information and may be transmitted to another node.

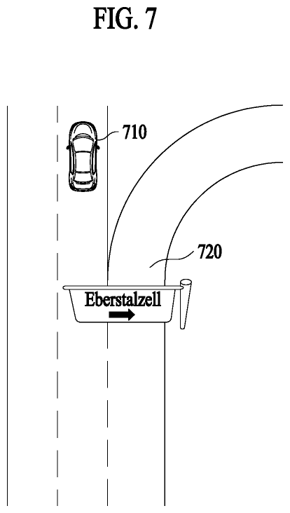

FIG. 7 is a view for explaining an unexpected situation according to another embodiment of the present disclosure.

Referring to FIG. 7, there is illustrated an environment in which a sudden lane change may occur near the route along which a driving vehicle is guided.

An embodiment describes the state in which a vehicle 710 failed to enter an exit 720 of the road on the route guided by a navigation system of the vehicle and passed exit 720. In this case, vehicle 710 may suddenly stop.

At this time, an operating apparatus associated with vehicle 710 may estimate a future change in the speed of vehicle 710 based on the current location of the vehicle, guided route information, the current speed of the vehicle, and driving history information of the vehicle. In an embodiment, when vehicle 710 is expected to brake rapidly, the operating apparatus may generate a driving information message including related information and may transmit the message to another node.

In addition, in an embodiment, the operating apparatus may estimate the probability of a rapid speed change based on the current location of the vehicle, guided route information, the current speed of the vehicle, and driving history information of vehicle 710. In an embodiment, whether or not to transmit a driving information message to another node may be determined based on the probability of the rapid speed change. In addition, in an embodiment, the driving information message may include probability information and may be transmitted to the other node.

In addition, in an embodiment, when the road, on which the vehicle travels, corresponds to a specific road, an operation corresponding to the above embodiment may be performed. More specifically, when the road corresponds to a highway and exit 720 of the road corresponds to an entrance or an exit through which the vehicle enters or leaves the highway, the operation corresponding to the above embodiment may be performed.

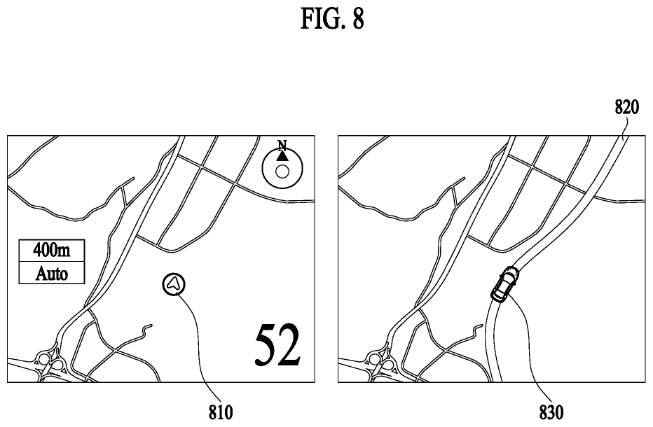

FIG. 8 is a view for explaining an unexpected situation based on navigation information according to an embodiment of the present disclosure.

Referring to FIG. 8, there is illustrated the case in which navigation information differs from actual road information.

In an embodiment, the left map illustrates map information provided by a navigation system. A current GPS vehicle location 810 is marked on the map, but present at a place other than the road included in the guidance map of the navigation system since information on the road on which the vehicle is currently driving is not updated.

In an embodiment, the right map illustrates a road 820 on which a vehicle 830 is actually driving. In an embodiment, road 820 is a newly opened road and is not yet updated in the navigation system.

In an embodiment, the driver of vehicle 830 needs to drive on road 820 that is not guided by the navigation system, and in this case, the driver has a higher probability of making an unexpected behavior than usual since the driver does not receive the help of guidance information. In this case, an operating apparatus may transmit a driving information message indicating that there is the probability of an unexpected behavior to another node. In an embodiment, an operating apparatus of another vehicle which has received such a message may recognize vehicle 830 as a vehicle requiring attention. In this case, since there is a high probability of the unexpected behavior, the operating apparatus of the other vehicle may provide information required to perform an operation of maintaining a greater distance from vehicle 830 than in other vehicles.

In an embodiment, the probability of an unexpected situation in such an environment may be determined based on information on the driving experience of a vehicle driver. In an embodiment, the operating apparatus may estimate a lower probability of an unexpected situation in the same environment when the vehicle driver has a long driving experience than when the driver has a short driving experience. In addition, in an embodiment, the operating apparatus may estimate a low probability of the unexpected situation when the vehicle driver has driven the same route more than a specific number of times. At this time, the specific number of times may be differently determined according to driver's driving experience.

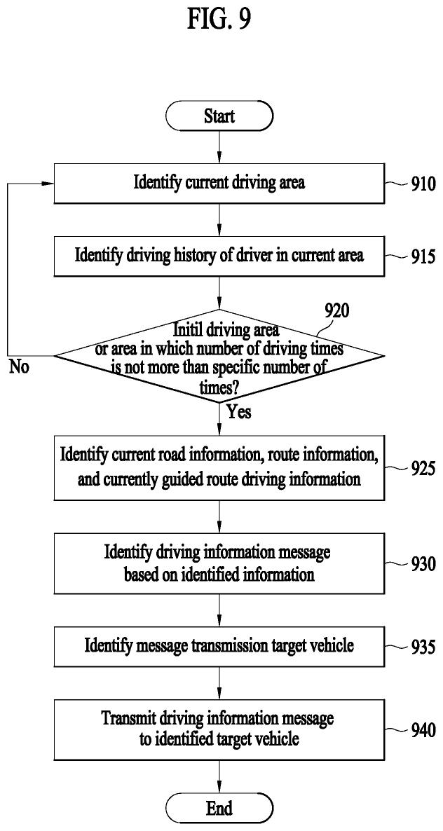

FIG. 9 is a flowchart illustrating a method of providing information to another vehicle based on information on the driving history of a driver according to still another embodiment of the present disclosure.

Referring to FIG. 9, there is illustrated a method of generating a driving information message based on driving history and transmitting the message to another vehicle by an operating apparatus associated with a vehicle.

In step 910, the operating apparatus may identify information on the area in which the vehicle is currently driving. More specifically, in an embodiment, the operating apparatus may identify area information based on information on the area in which the vehicle is currently located and a driving route of the vehicle.

In step 915, the operating apparatus may identify information on the driving history of a driver in the identified area. In an embodiment, the driving history information may include whether the driver has experienced driving in the area in which the driver is currently located, information on the number of times the driver experiences driving, and information on the most recent driving time. The information may be identified based on information stored in a storage unit corresponding to the operating apparatus or information stored in an external node.

In step 920, the operating apparatus may determine whether the number of driving times is not more than a specific number of times in the identified driving area. The operating apparatus of the embodiment may determine whether the driver has previously driven not more than a specific number of times in the driving area based on at least some of the information identified in the previous steps. In an embodiment, the specific number of times may be determined according to information related to the identified area. For example, when accidents frequently occur in the area or when the number of roads connected to the area is more than a specific number, the specific number of times may be set higher than in other areas. In addition, in the case of a situation in which the area has a newly opened road, the specific number of times may be set higher than in other areas. In addition, in an embodiment, when the complexity of the road is more than a specific value, the specific number of times may be set higher than in other areas.

When the number of driving times is more than the specific number of times, the operating apparatus may determine that the driver is familiar to drive in the area, and may continue to monitor the area.

When the number of driving times is not more than the specific number of times, in step 925, the operating apparatus may identify information on the road of the area in which the vehicle is currently driving, guided route information, and information on the driving of the vehicle on the currently guided route. In an embodiment, the area road information may include one of the location of the road and the volume of traffic on the road. The driving information of the vehicle on the currently guided route may include at least one of the location of the vehicle, the location of the lane of the road in which the vehicle is located, and the speed of the vehicle.

In step 930, the operating apparatus may identify a driving information message based on the identified information. In addition, in an embodiment, the operating apparatus may identify a driving information message in consideration of information on the driving history of the driver. In an embodiment, the driving information message may include vehicle driving information. For example, when the driver drives on an unfamiliar road, there is a high probability of an unexpected behavior, and the driving information message may include information indicating this high probability. In addition, the driving information message may include information on the behavior that the driver has normally made on an unfamiliar road, which is identified based on the driving history information of the driver. In addition, in an embodiment, the driving information message may include information on the probability of the unexpected behavior based on at least some of the information identified in the previous steps.

In step 935, the operating apparatus may identify a target vehicle to which the driving information message is to be transmitted. In an embodiment, the operating apparatus may broadcast the driving information message to all adjacent vehicles without a separate identifying procedure. In addition, in an embodiment, the target vehicle may be identified based on at least some of the information identified in the previous steps. For example, a vehicle that may be affected by the information included in the driving information message may be identified as the target vehicle.

In step 940, the operating apparatus may transmit the driving information message to the identified target vehicle. In an embodiment, the operating apparatus may repeatedly transmit the driving information message to the target vehicle.

By generating a driving information message based on the driver's driving experience and providing the driving information message to another vehicle, the other vehicle may identify in advance information about whether a driver of the vehicle having a short driving experience driving in the area may affect the other vehicle. In addition, a driver of the other vehicle may perform defensive driving based on such information, and in the case of autonomous driving, parameters related to autonomous driving may be adjusted based on such information.

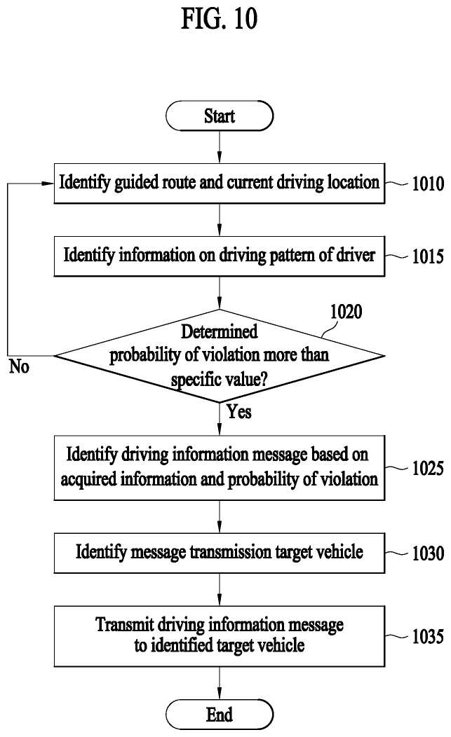

FIG. 10 is a flowchart illustrating a method of providing information to another vehicle based on information on the driving pattern of a driver according to yet another embodiment of the present disclosure.

Referring to FIG. 10, there is illustrated a method of identifying information on the driving pattern of a driver and transmitting a driving information message based on the identified information.

In step 1010, an operating apparatus may identify information on the route along which a vehicle is guided and information on the current driving location of the vehicle. The guided route may include information on a route to a destination. The driving location information may include information on a positional relationship with the destination. In addition, in an embodiment, the driving location information may include information on a positional relationship with the road on the route which is to be guided next. For example, in the case of information guiding a route along which the vehicle makes a U-turn after moving straight and then turns to the right, the driving location information may include information on a positional relationship between the current location of the vehicle and the road that the vehicle enters by turning to the right.

In step 1015, the operating apparatus may identify information on the driving pattern of a driver. In an embodiment, the driving pattern information may include information about whether the driver tends to drive off a specific route on the road similar to the road in which the driver is currently located. In addition, the driving pattern information may include information about whether the driver tends to violate a traffic regulation.

In step 1020, the operating apparatus may determine, based on at least one of the information identified in the previous steps, whether the probability that the driver violates at least one of the guided route and the traffic regulation at the current location is more than a specific value. In an embodiment, the operating apparatus may determine, based on the driver's driving history information, the probability that the driver violates a traffic regulation at the current driving location. In an embodiment, the violation of the traffic regulation may include at least one of a centerline violation and an unacceptable left turn or right turn, and may include any other traffic regulation violation which is not enumerated herein but difficult for other vehicles to anticipate.

When the probability of violation is not more than the specific value, the operating apparatus may continue to monitor.

When it is determined that the probability of violation is more than the specific value, in step 1025, the operating apparatus may generate a driving information message based on at least one of the acquired information and the probability of violation. More specifically, the driving information message may include information on at least one of the direction in which the driver of the vehicle may drive and the speed of the vehicle based on the acquired information. In an embodiment, the driving information message may include information on the probability that the vehicle may move in the direction.

In step 1030, the operating apparatus may identify a target vehicle to which the driving information message is to be transmitted. In an embodiment, the target vehicle may include a vehicle present within a specific distance range from the vehicle of the driver. In addition, the target vehicle may include another vehicle, the driving of which may be affected when the vehicle is driven according to the information included in the driving information message.

In step 1035, the operating apparatus may transmit the driving information message to the identified target vehicle.

In this way, vehicle accidents may be prevented by determining the probability that a vehicle is driven unexpectedly based on information on the area in which the vehicle is currently located and information on the driving pattern of a driver of the vehicle and providing the probability information to another vehicle.

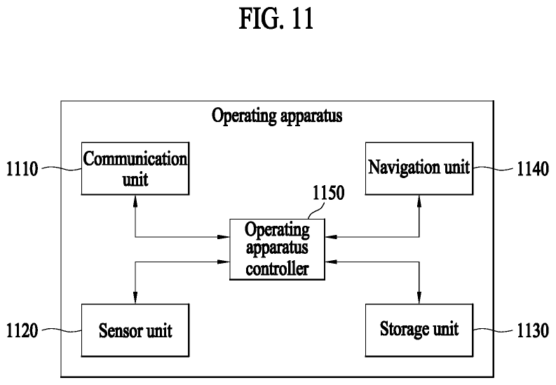

FIG. 11 is a view for explaining the operating apparatus according to the embodiment of the present disclosure.

Referring to FIG. 11, the operating apparatus of the embodiment may include a communication unit 1110, a sensor unit 1120, a storage unit 1130, a navigation unit 1140, and an operating apparatus controller 1150.

Communication unit 1110 may transmit and receive information to and from the operating apparatus and another node. For example, the operating apparatus may communicate with at least one of a vehicle corresponding to the operating apparatus, another vehicle, a cellular communication system, and a server through communication unit 1110. In addition, communication unit 1110 may receive information for acquiring the location of the vehicle in cooperation with a GPS.

Sensor unit 1120 may receive information on the vehicle corresponding to the operating apparatus. More specifically, sensor unit 1120 includes sensors capable of acquiring image information, sound information, location information, and acceleration information. The operating apparatus may acquire the vehicle information in real time via sensor unit 1120.

Storage unit 1130 may include a nonvolatile memory, and may store information on the operating apparatus. Storage unit 1130 may store at least one of information for controlling the operating apparatus, information transmitted and received through communication unit 1110, and information for driving navigation unit 1140. In addition, in another embodiment, storage unit 1130 may store information corresponding to the operation of the operating apparatus.

Navigation unit 1140 may guide a route to the vehicle and may provide peripheral traffic information. In an embodiment, navigation unit 1140 may be a typical navigation system, and additionally, under the control of operating apparatus controller 1150, may provide a user with vehicle driving information using information received from another node of the operating apparatus.

Operating apparatus controller 1150 may control a general operation of the operating apparatus, and may perform a general operation related to the operating apparatus described in the embodiments of the disclosure.

Meanwhile, in an embodiment, navigation unit 1140 may be realized in software by the control of operating apparatus controller 1150.

From the foregoing, it will be appreciated that various embodiments of the present disclosure have been described herein for purposes of illustration and that specific terms have been used, but are merely used in a general sense to easily explain the technical content of the present disclosure and to help easy understanding of the present disclosure and are not intended to limit the scope of the present disclosure. Those skilled in the art will appreciate that various other modifications based on the technical idea of the present disclosure are possible.

What is claimed is:

1. A method of providing vehicle driving information at an operating apparatus, the method comprising:
acquiring vehicle driving history information corresponding to a driver;
estimating driving information of a vehicle based on the acquired history information; and
transmitting, to a target vehicle, information on driving of the vehicle identified based on the estimated driving information, when the estimated information corresponds to a specific condition.

2. The method of claim 1, wherein the estimating the driving information includes estimating the vehicle driving information based on navigation route guidance information of the vehicle and current driving information of the vehicle.

3. The method of claim 2, wherein the estimating the driving information includes:
identifying information on a forked road present in a heading direction of the vehicle;
identifying information on a driving lane of the vehicle; and
estimating occurrence of a lane change to a route indicated by the route guidance information when the driving lane on the forked road does not correspond to the route indicated by the route guidance information.

4. The method of claim 2, wherein the estimating the driving information includes:
identifying whether the vehicle has moved on the forked road in a direction different from the route guidance information; and
estimating that there occurs a change in a speed of the vehicle when the vehicle moves in the direction different from the route guidance information and the forked road corresponds to a specific type of forked road.

5. The method of claim 1, wherein the vehicle driving history information includes information on whether the driver has a history of driving a current driving route of the vehicle.

6. The method of claim 5, wherein the estimating the driving information includes estimating the vehicle driving information based on at least one of information on a complexity of a current driving road, information about whether the vehicle has approached a destination, and information on a number of times the vehicle droves off a navigation guidance route when the driver has no history of driving the current driving route of the vehicle.

7. The method of claim 1, further comprising:
identifying information on an actual road on which the vehicle is on; and
identifying navigation map information of the vehicle,
wherein the vehicle driving information is estimated further consideration of the actual road information and the map information.

8. The method of claim 1, wherein the estimating the driving information includes estimating the vehicle driving information based on information on a driving pattern of the driver, information on a road on which the vehicle travels, and information on a route along which the vehicle is to travel.

9. The method of claim 1, wherein the transmitting the information on driving of the vehicle includes transmitting a message including information that enables identification of the vehicle to the target vehicle, and
wherein the message includes at least one of information on a driving pattern of the vehicle, information on a driving direction of the vehicle, information on a probability that the vehicle travels in the driving pattern, and time information corresponding to the message.

10. The method of claim 1, further comprising identifying the target vehicle, to which information on a driving pattern of the vehicle is to be transmitted, based on at least one of the vehicle driving history information, information on a route along which the vehicle is guided, and current driving information of the vehicle.

11. The method of claim 1, further comprising identifying the target vehicle, to which information on a driving pattern of the vehicle is to be transmitted, based on information received from a server,
wherein the information received from the server includes information on the target vehicle corresponding to information on a route along which the vehicle is guided.

12. The method of claim 1, further comprising:
identifying whether the vehicle travels based on information on a driving pattern of the vehicle; and
additionally transmitting the vehicle driving pattern information to the target vehicle based on a result of the identifying.

13. The method of claim 1, wherein the information on driving of the vehicle includes at least one of information on a direction in which the vehicle moves, information on a change in a speed of the vehicle, and information on a probability that the vehicle is to move at the speed in the direction.

14. The method of claim 1, further comprising:
receiving driving route guidance information of another vehicle;
acquiring at least one of information on a driving lane of the other vehicle, information on a speed of the other vehicle, and information on a driving direction of the other vehicle; and
providing estimated traveling information of the other vehicle when the estimated traveling information satisfies the specific condition.

15. The method of claim 1, further comprising:
identifying whether the vehicle travels based on the estimated information; and
updating the history information based on a result of the identifying.

16. The method of claim 1, wherein the vehicle driving information is identified using an artificial intelligence learning module based on the history information.

17. An operating apparatus of providing driving information, the operating apparatus comprising:
a transceiver configure to communicate with another vehicle; and
a controller configured to:
control the transceiver,
estimate driving information of a vehicle based on the acquired history information; and
transmit, to a target vehicle, information on driving of the vehicle identified based on the estimated driving information, when the estimated information corresponds to a specific condition.

18. An operating apparatus of displaying driving information, the operating apparatus comprising:
a display;
a transceiver; and
a controller configured to:
receive driving information including information on driving of another vehicle through the transceiver, and
control the display to display the received driving information of the other vehicle,
wherein the driving information includes information on the driving of the other vehicle estimated based on driving history information of a driver of the other vehicle.
